(19) United States
(12) Patent Application Publication
(10) Pub. No.: US 2015/0032577 A1
(43) Pub. Date: Jan. 29, 2015

(54) System and method for generating revenue for publishers of multimedia content over a network

(71) Applicant: Yahoo! Inc., Sunnyvale, CA (US)

(72) Inventor: Ethan Fassett, San Francisco, CA (US)

(21) Appl. No.: 14/514,515

(22) Filed: Oct. 15, 2014

Related U.S. Application Data
(63) Continuation of application No. 11/591,948, filed on Nov. 2, 2006.

(51) Int. Cl. G06Q 20/12; G06Q 30/06

(52) U.S. Cl. CPC G06Q 20/123; G06Q 30/0635; G06Q 20/127
USPC 705/26.81

(57) ABSTRACT

A system and method for compensating publishers of content items, such as a video, graphics, songs, movies, images, advertisements, or any other type of content, in response to, or as a precondition to, viewing of a given content item by others at a host website. For example, multimedia content publishers upload their respective content items to a host website. The uploaded content items may be integrated into a video search engine, which is a feature of the host website. A given user wishing to view a given content item remunerates the publisher of the content item with payment through a third party payment provider, which may be a donation or minimal payment. Payment may be effected via a third party payment system such as PayPal™ of San Jose, Calif.

### CROSS-REFERENCE TO RELATED APPLICATION

The present application is a continuation of and claims priority to U.S. patent application Ser. No. 11/591,948, filed Nov. 2, 2006, entitled, SYSTEM AND METHOD FOR GENERATING REVENUE FOR PUBLISHERS OF MULTIMEDIA CONTENT OVER A NETWORK, which is incorporated herein by reference in its entirety.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention relates generally to user generated content. More specifically, the present invention relates to methods and systems for directly compensating publishers of content viewed by others over a network.

### BACKGROUND OF THE INVENTION

The Internet has proven to be an effective communication medium. Via search, e-mail and the personalization of chosen web sites, individuals have been empowered to easily gather more of the information they want. On-line consumers are always looking for ways to find the businesses they are interested in without spending hours searching the Internet. Despite its utility as an effective communication medium, the Internet has yet to realize its full potential, in part because content producers have not found sufficient means with which to monetize certain distribution channels. Specifically, many types of content have been freely distributed over various web pages and information services. This trend is slowly changing as the market for user-generated video content (“UGC”) is beginning to take shape. For example, Yahoo!™ (home page: www.yahoo.com), a well-known Web portal, includes a section called Yahoo! Video™ that allows users to publish their UGC to the general public. FIG. 1 shows a screen-shot of the Yahoo!™ Video™ home page.

Presently, no successful business model for the UGC market has proven itself out. The barriers surrounding successful monetization of video UGC are several-fold. First and foremost, there is no proven pricing model for UGC, as it is novel to the market. As such, there is no pricing standard by which to value UGC. Another barrier to monetization is recognition of the fact that the quality of UGC is highly subjective and variable, thus rigid pricing models are difficult to apply. Advertising models are also difficult to apply to UGC because the quality variance dissuades advertisers from committing to inventory. Quality is difficult for automated systems to determine, and as of yet none exist to sufficiently serve the video UGC market. A further barrier to monetization is that revenue sharing models for existing and proposed business models that sufficiently compensate publishers and distributors do not yet exist at scale, are very difficult to test and implement, and likely will be costly to implement. Thus, systems and methods are needed for the improved monetization of user generated content.

### SUMMARY OF THE INVENTION

Therefore, the present invention has been made in view of the above problems, and it is an objective of the present invention to provide a method and system for compensating publishers of content items, such as a video, graphics, songs, movies, images, advertisements, or any other type of content, in response to viewing of a given content item by others at a host website. According to one embodiment, multimedia content publishers upload their respective content items to a host website. The uploaded content items may be integrated into a video search engine, which according to one embodiment is a feature of the host website. A given user wishing to view a given content item directly remunerates the publisher of the content item with payment, which may be a donation or minimal payment. Payment is effected via a third party payment system, such as PayPal™ of San Jose, Calif. The third party payment system advantageously enables the host website to offset any transaction management infrastructure, thereby removing itself from financial obligations to any party for revenue sharing or payment.

### BRIEF DESCRIPTION OF THE DRAWINGS

These and other objects, features and advantages of the present invention will become apparent through consideration of the Detailed Description of the Invention, when considered in conjunction with the drawing Figures, in which:

FIG. 1 is a screen-shot of a browser window presenting a representative content provider according to the prior art;

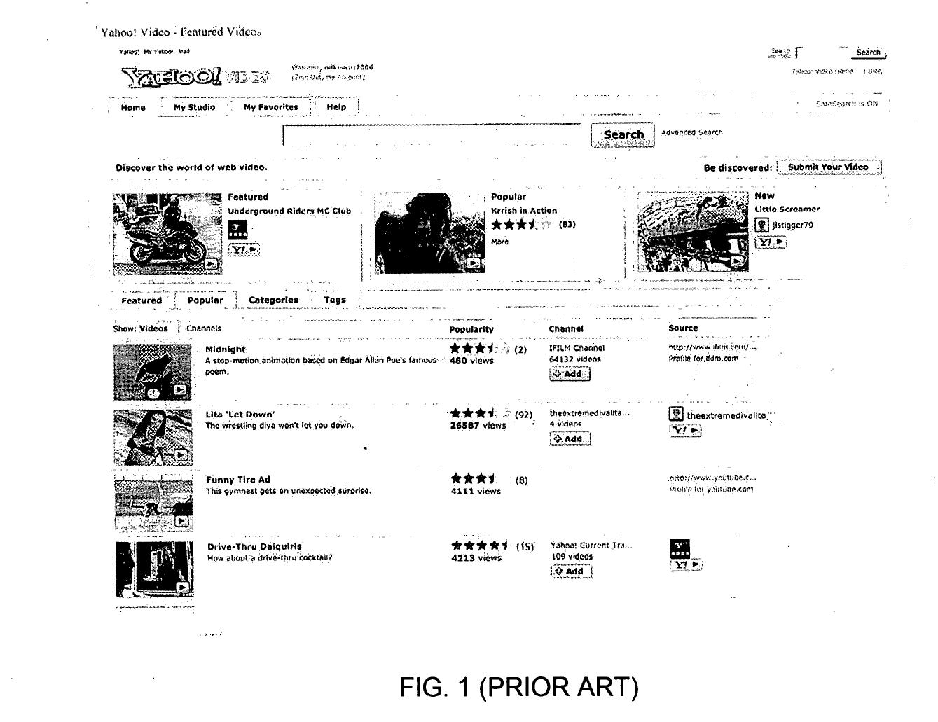

FIG. 2 illustrates a system for the facilitation of payment for user generated content according to one embodiment of the present invention;

FIG. 3 illustrates a method for compensating publishers of UGC according to one embodiment of the present invention;

FIG. 4 is a screen diagram illustrating controls for payment of an item of UGC presented at a home page of a video search engine according to an embodiment of the invention;

FIG. 5 is a screen diagram illustrating controls for payment of an item of UGC presented at a channel page of a video search engine according to an embodiment of the invention; and

FIG. 6 is a screen diagram illustrating controls for payment of an item of UGC presented at an item detail page of a video search engine according to an embodiment of the invention.

### DETAILED DESCRIPTION OF THE EXEMPLARY EMBODIMENTS

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

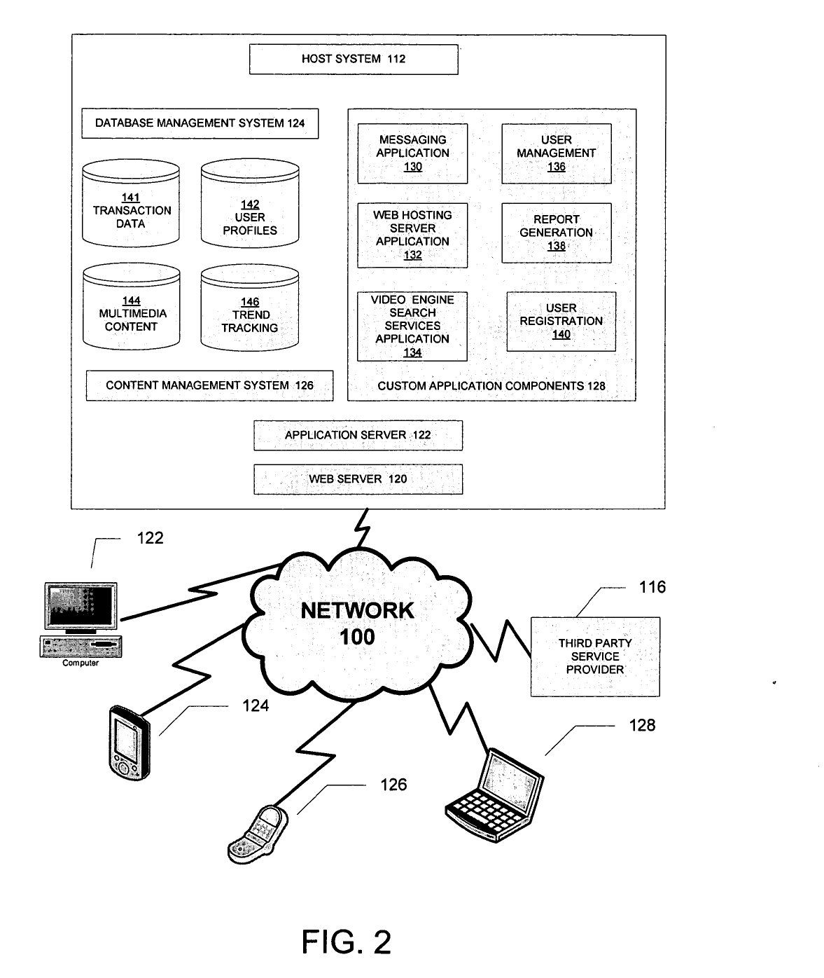

FIG. 2 is a block diagram illustrating an architecture of a system 100 for facilitating payment to access UGC in accordance with one embodiment of the invention. The system 100, in one embodiment, includes a host system 112 comprising a set of infrastructure components (Web Server 120, Application Server 122, database management system (DBMS) 124, and Content Management System 126) and a set of application components 128 and database components, including transaction data 141 and user profiles 142 and content 144. Each component or subsystem of the system 100 may be in operable communication with other components of the system 100, as necessary, for example, through the use of remote method invocation (“RMI”) or other component messaging services in the case of software, or bus interconnects in the case of hardware such as disk drives for the persistent storage of data stores.

In exemplary embodiments, host system 112 refers to an entity hosting content items (such as multimedia content items) uploaded by content publishers to the host system 112, as described further herein. Host system 112 may comprise a service provider such as an Internet service provider, web hosting service provider, a web portal provider, or similar type of business enterprise. As shown and described with respect to the embodiment of FIG. 2, host system 112 is a web portal provider that may provide a web portal, web hosting services, messaging services, as well as a video search engine service to its customers. The Yahoo!™ network is one example of a service provider providing these services. Host system 112 provides a web portal interface for its customers through which various services may be accessed and implemented. The web portal interface may include general information and links to external sources of information and may also provide the main interface for initiating the services available through the multi-media content storage, management and search system.

Continuing with FIG. 2, the custom application components 128 include components developed to accomplish some of the functions of the system 112 described herein. In at least one embodiment, the custom application components 128 includes components such as a messaging application 130, a web hosting server application 132, a video engine search services application 134, user management application 136, and report generation application 138. Messaging applications 130 may include email, text messaging, chat rooms, message boards, newsletters, instant mail, etc, including digital communications known to those of skill in the art. The video engine search services application 132 provides users with the ability to search and view an online repository of multimedia content items, such as online digital video, and audio content.

User management 136 subsystem may provide user management functions for users of the host system 112. These users, in at least one embodiment, are publishers of UGC and viewers of said UGC. For example, in at least one embodiment, the user management 136 subsystem provides an interface to data such as user profile data, user preference data, stored search results, lists of content items (including UGC) for which a user has paid a given amount to view, or other information. A user registration component 136 may also handle initial site registration, login and authentication functions, as well as profile management.

The content pages of the content management system 126, in one embodiment, include a plurality of content pages. In one embodiment, the content pages include HTML templates, as well as pages for dynamic and static content pages. The types of content pages are not intended to be limiting; those skilled in the art recognize that many types of content pages may be provided in accordance with the invention.

Additionally, content pages may comprise individual content items, such as audio, video, image, text and other content.

A multimedia content database 140 stores user generated content items provided by content publishers and provides access to the user generated content items upon request from other users of the host system 112, e.g., viewers of a given content item. Content includes, e.g., digital images and albums, video and video libraries, audio libraries, etc. Multimedia content database 140 may also store a music base, video base, and/or computer games for selection by customers. The database 140 may comprise any type of data store for the storage of content items including, but not limited to, a flat file data store, a relational database, an object oriented database, a hybrid relational-object database, etc.

Client devices 122 and 124 are also in communication with the system of FIG. 2 in accordance with exemplary embodiments. Client devices 122 and 124 refer to devices operated by customers of host system 102, e.g., viewers of content items. Client devices 122, 124 may include wired computer devices, wireless computing devices, smartphones, PDAs, and similar network-enabled devices. A mobile telephone client device may include a built-in digital camera/video recorder and features for transmitting images, video and sound by telephone to host system 112, e.g., UGC generated through use of the mobile telephone client. Similarly, a digital/video camera may be coupled to a computer client device whereby images, video and audio may be uploaded to host system 112.

Client devices 122 and 124 may communicate with host system 112 over a communications network 116, such as a packet-switched network (Internet, Extranet, Virtual Private Network) using various packet-switching technologies such as Internet Protocol (IP), frame relay, asynchronous transfer mode (ATM), among others. Client devices may also communicate over a wireless network, e.g., a cellular or satellite communications network. Client devices 122 and 124 access the network 110 via, e.g., a modem and dial up service, broadband cable Internet service, wireless service provider, etc. Client devices 122 and 124 may include web browsers, messaging applications, content player applications (e.g., video and/or audio).

In an exemplary embodiment, the client devices 122 and 124, establish a new or have an existing relationship or association with the host system 112. For example, in one embodiment, the client devices 122 and 124 are members of the Yahoo!™ network client base. In general, client devices 122 and 124 may be members of any suitable web portal service that provides video search engine services.

Third party service provider system 116 provides transaction management infrastructure payment services in support of host system 112. Client devices 122 and 124 interact with the third party service provider system 116 to accomplish payment for viewing certain content items published by the UGC content publishers. Exemplary third-party payment services 116 include, for example, PayPal™, e-count.com™, Xign.com™, BidPay™ Payment Service operated by BidPay.com™, Inc. of Bridgeton, Mo.; Bill Me Later™ operated by Commerce™ of Timonium, Md.; or other similar electronic payment systems.

As used herein, the term “payment service” may represent any computer application, process, entity, or device operative to process payment transactions and accessible to other applications, processes, entities, or devices. According to one embodiment, the third party service provider 116 is accessible through an interface such as an application programming interface (API), user interface, or Internet web user interface by any of a variety of protocols over a network within an entity or over the Internet. A service may also comprise multiple methods or applications on a single device or distributed across multiple devices. An interface may comprise functions such as those discussed in the “Website Payments Standard Integration Guide” and “Website Payments Professional Integration Guide” published by PayPal™, which are incorporated herein by reference in their entirety.

A user is granted access to a given content item by selecting a corresponding payment button that may be presented in conjunction with a given content item. Selection of the payment button or similar control executes a call to an API, which may be a web service, to support integration with the third party payment system 116, which is described in greater detail below.

When a user 126 and 128 selects the payment button on a given page to view a content item, the content management system 126 may access a user profile database 142 of the host system 112 to determine whether the user has previously paid for the requested multimedia content item. If not, the API call redirects the user of a given client device 126 and 128 to a third party payment site 116 (e.g., PayPal) for execution of the payment transaction. Certain parameters are passed to the third party payment site 116 through the API. They may include, in at least one embodiment, the minimum payment made by the user, information regarding the referring page, etc. Once payment is confirmed by the third party payment site 116, the client device 126 and 128 is redirected back to the host system 112 along with certain parameters provided by the third party payment site 116. These parameters may include, in at least one embodiment, setting a flag to confirm payment. These parameters may be retained in a user profile for the user in the user profiles data store 142. Upon redirection, the user may access the content item provided that the successful payment flag is set.

A further feature of the present invention is that the host system 112 may be configured to compile and store information (e.g., trend data) on the publishers of UGC and end users of the system (e.g., consumers of UGC). In one embodiment, the host system 112 includes a software program or trend tracking database 146 that reads, stores, and assimilates information regarding (1) whether an la carte, donation, or other payment method for accessing uploaded UGC is amenable to its user base, (2) how publishers of UGC try to promote their content on the network when that content is for sale or other remuneration, (3) which producers are developing content that the user base is purchasing and why, (4) what range of pricing is more or less effective for various types of content, and (5) what are the attributes of a given item of UGC that make it more “sellable”.

Regardless of the structural embodiment, however, this compiled information allows the host system 112 to track trends in an effort to better market user generated content and to better serve the needs of the user base. For example, if, based on the compiled information, the host system 112 finds that a majority of its user base is not willing to pay more than a threshold amount for various types of UGC, the host web site may impose an appropriate price ceiling on a given category of UGC. Likewise, if the host system 112 finds that its user base is willing to pay any price for various types of content, then it may leave pricing decisions to the respective content providers. Similarly, this compiled information allows the host system 112 to track, for example, the volume of sales for a given item of UGC offered for sale, both on a category-wide basis and on an individual basis.

In an exemplary embodiment, when a given client 126 and 128 purchases rights to view a given item of UGC from the host system 112, certain parameters associated with the purchase are recorded in the trend tracking database 146. These parameters may include, the minimum payment made to view the multimedia content, the title, category, producer, user id, etc., for example, which are recorded, compiled, and stored in the trend tracking database. A management entity associated with the host system 112 may then review and track the likes, dislikes and overall history of a given client. This allows for the host system 112 to track, on a user by user basis, which content producers are most popular with clients, what pricing structure is most appealing to clients and which attributes of user generated multi-media content make it more “sellable”. Accordingly, the tracking system can provide an operator of the host system 112 a rather easy way of compiling trend data in order to better serve their user base and to better market video UGC to their user base.

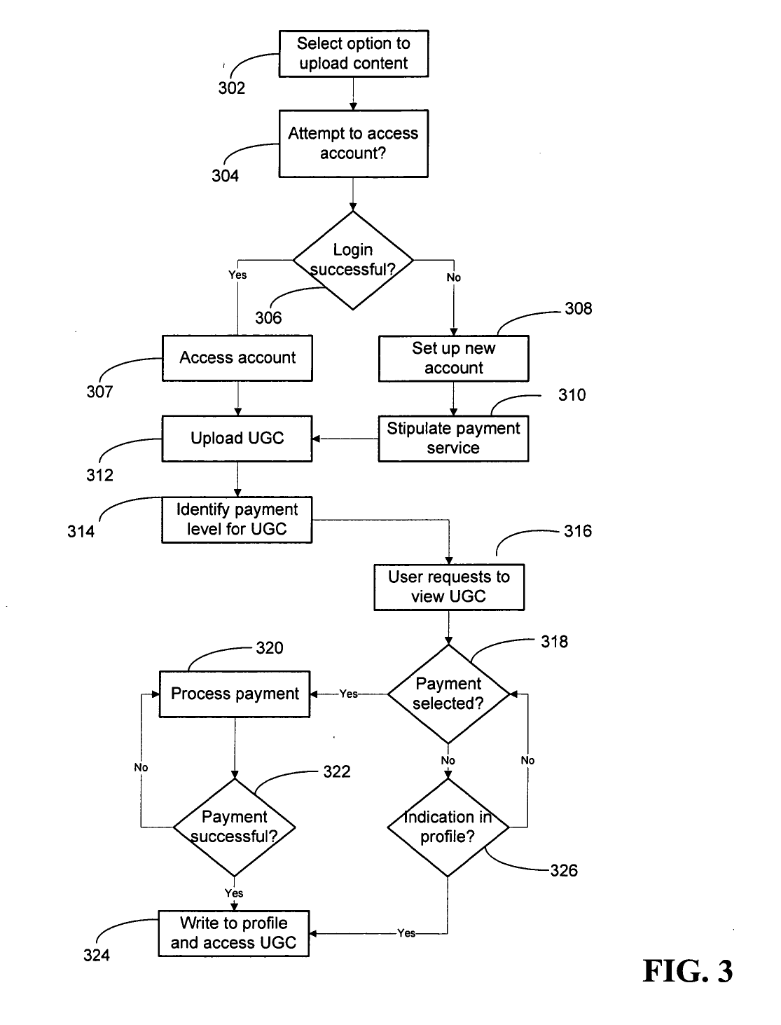

With reference now to FIG. 3, a process for compensating publishers of UGC according to one embodiment of the present invention is now described. The process illustrates one embodiment of an overall routine that may be implemented in software running on one or more servers of the host system.

As shown in FIG. 3, a publisher of UGC logs on to the host system and requests or otherwise selects to upload one or more content items (step 302). To upload multi-media content to the host system, a content producer attempts to sign into his or her respective account through an account interface (step 304). If an account is not set up already (steps 306 and 307), then the content producer sets up an account before proceeding (step 308). Part of setting up an account includes the content producer stipulating a payment service (step 310). Once the content producer opens an account (step 308), or accesses an existing account (step 307), the content producer may upload one or more items of UGC (step 312). Uploading content facilitates the integration of the uploaded content items into a search index as part of the video search engine application.

According to one embodiment of the invention, when uploading a content item the content producer may identify a payment level (step 314). A payment level may be a solicitation for a donation, a fixed price, a donation with a set floor, etc.

One service that offers functions for online payment reconciliation is PAYPAL™. PAYPAL™ allows a given user to send money for such purposes as paying for an auction item, paying for an online purchase, or paying bills online. In fact, PAYPAL™ allows a user to send money to anyone with an email address by entering the recipient's email address and the amount of the desired payment. The recipient gets an email informing them that payment has been sent and instructions on how to collect by visiting PAYPAL™'s web site. PAYPAL™ receives its payment by credit card, checking account or other financial instruments.

Users of the video search engine feature wishing to view a given video may navigate to a search engine service home page (step 316), such as the one provided by Yahoo!™ Video that lists UGC that have been uploaded by content providers to the video search engine service. As is show in greater detail in accordance with the exemplary screen illustrations described herein, a given content item the search engine makes available may be associated with a link to provide payment for the viewing of the given content item. A check may be performed to determine if the user selects a payment link prior to attempting to view a given content item (step 318). Where the user selects the link to provide payment, the client device of the user is directed to a server that a third party payment provider operates to provide payment in accordance with a payment level for the given content item (step 320).

After the user completes the payment transaction at the third party payment provider, (step 320), the user is directed back to the host system, where a check may be performed to determine if the third party payment provider has set a flag or otherwise indicates that the payment transaction was successful (step 322). Where the third party payment provider indicates that the transaction was successful, an indication is written to the profile for the user and he or she accesses the selected content item (step 324). If unsuccessful, the user may be provided with one or more additional opportunities to successfully provide payment (step 320). Where a user attempts to view a content item without selecting a payment control (step 318), a check of the profile for the user is made to determine if payment was made previously (step 326). If the check evaluates to true, the system provides the user with access to the content item (step 324). Where the check evaluates to false, the system continues to check for user selection of the payment control (step 318).

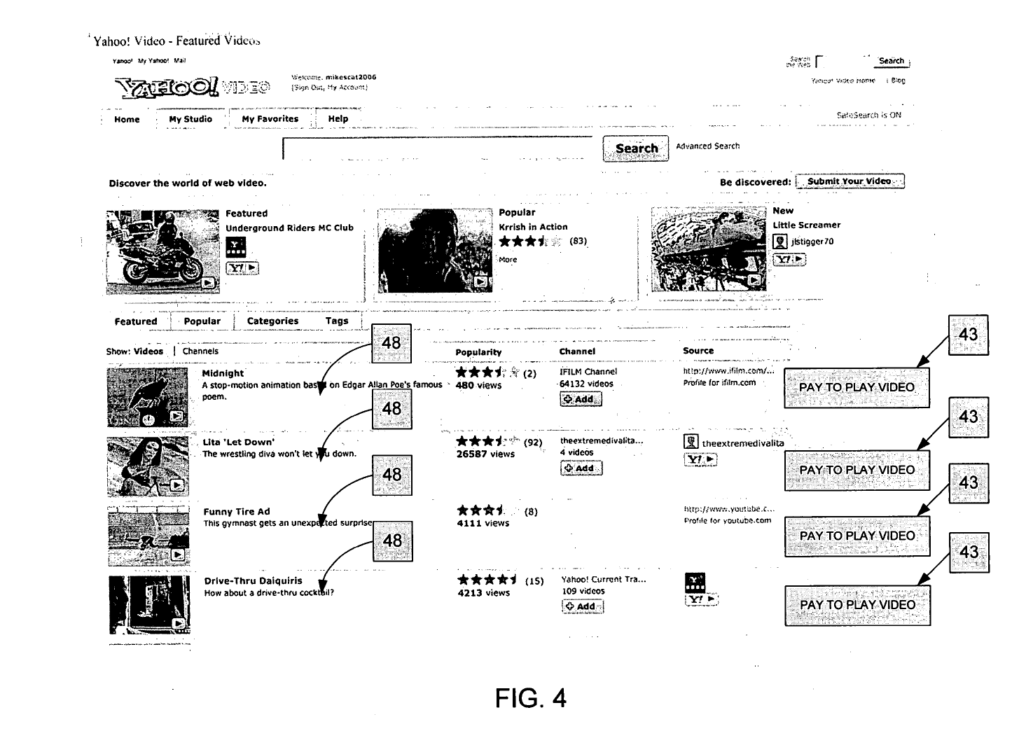

FIG. 4 shows a screen diagram illustrating an exemplary interface to a video search engine of the host system in accordance with one embodiment of the invention. The exemplary interface comprises a “payment” button 43 displayed next to a given item of UGC 48 in the list of items of UGC. The “payment” button 43 indicates that the multimedia content publisher, who has uploaded the corresponding item of user generated content to the search engine, is requesting a direct donation to view the given item of UGC. In various embodiments, the payment can comprise a donation, a suggested minimal amount, a required or mandatory minimal amount, or any other form of remuneration contemplated by the content publisher.

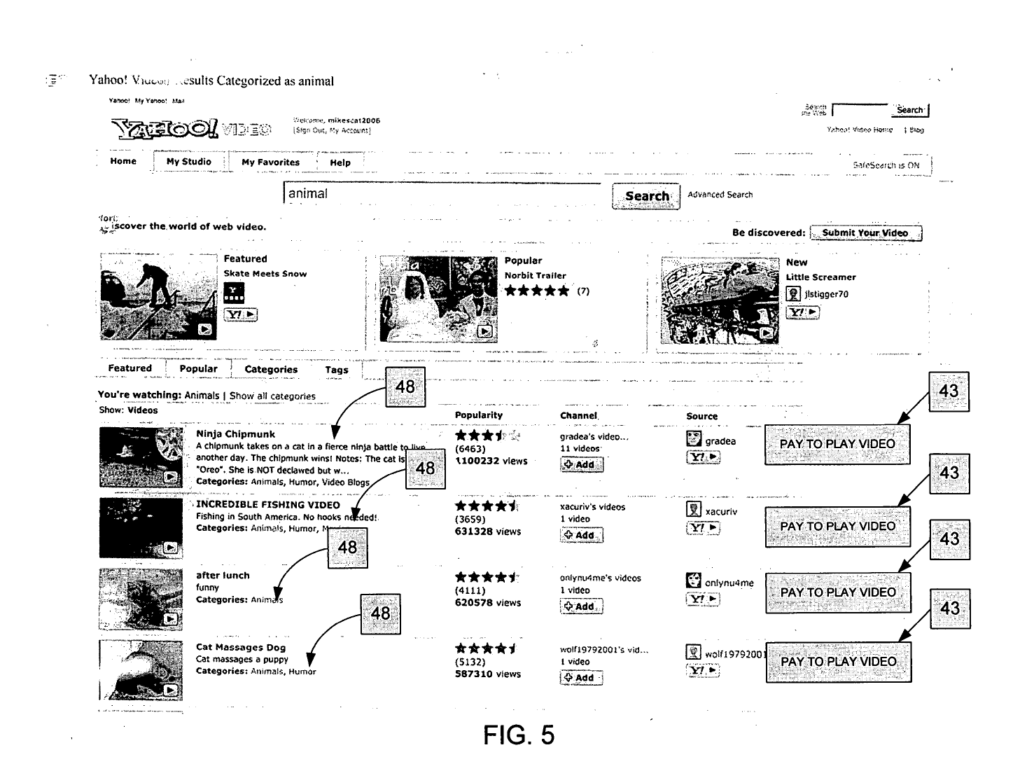

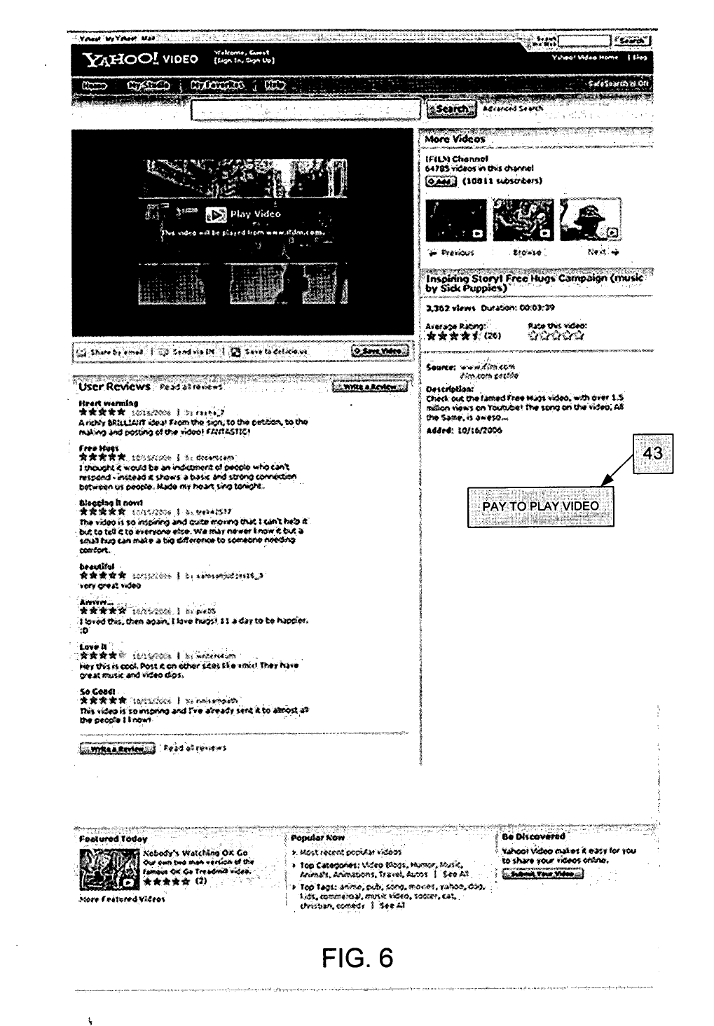

To facilitate transactions at many levels in the user experience, it is contemplated to place the payment button or similar control in a number of locations throughout the video search engine. For example, in addition to displaying the payment button 43 as shown on the exemplary home page of FIG. 4, it may also be displayed next to items of UGC organized in accordance with one or more pages and displayed on a channel page, as shown in FIG. 5, as well as on a page for a given item of UGC presented on a UGC item detail page as shown in FIG. 6.

FIGS. 2 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed:

1. A method, implemented on a machine having at least one processor, storage, and a communication platform connected to a network for facilitating a purchase, comprising:
obtaining information on an item to be offered for sale via the network;
analyzing the information to determine a category into which the item is classified;
selecting a pricing structure to be utilized to determine a price of the item based on the category of the item; and
informing a potential purchaser of the selected pricing structure to facilitate the potential purchaser to purchase the item.

2. The method of claim 1, wherein the pricing structure includes one of a fixed price, a bidding pricing scheme, and a donation with a minimum price.

3. The method of claim 1, wherein the selecting is further based on at least one of past transaction histories of:
a party that offers the item for sale;
the potential purchaser; and
items in the category.

4. The method of claim 1, further comprising directing the potential purchaser to a third party for purchasing the item in accordance with the selected pricing structure.

5. The method of claim 1, wherein the item includes at least one of a piece of content and a tangible item.

6. The method of claim 5, wherein the piece of content includes at least one of a textual content, an image, an audio, a video, and a combination thereof.

7. A system having at least one processor, storage, and a communication platform connected to a network for facilitating a purchase, comprising:
a database management subsystem configured for obtaining information on an item to be offered for sale via the network;
a content management subsystem configured for analyzing the information to determine a category into which the item is classified and selecting a pricing structure to be utilized to determine a price of the item based on the category of the item; and
a user management subsystem configured for informing a potential purchaser of the selected pricing structure to facilitate the potential purchaser to purchase the item.

8. The system of claim 7, wherein the pricing structure includes one of a fixed price, a bidding pricing scheme, and a donation with a minimum price.

9. The system of claim 7, wherein the selecting is further based on at least one of past transaction histories of:
a party that offers the item for sale;
the potential purchaser; and
items in the category.

10. The system of claim 7, wherein the user management subsystem is further configured for directing the potential purchaser to a third party for purchasing the item in accordance with the selected pricing structure.

11. The system of claim 7, wherein the item includes at least one of a piece of content and a tangible item.

12. The system of claim 11, wherein the piece of content includes at least one of a textual content, an image, an audio, a video, and a combination thereof.

13. A machine-readable tangible and non-transitory medium having information for facilitating a purchase, wherein the information, when read by the machine, causes the machine to perform the following:
obtaining information on an item to be offered for sale;
analyzing the information to determine a category into which the item is classified;
selecting a pricing structure to be utilized to determine a price of the item based on the category of the item; and
informing a potential purchaser of the selected pricing structure to facilitate the potential purchaser to purchase the item.

14. The medium of claim 13, wherein the pricing structure includes one of a fixed price, a bidding pricing scheme, and a donation with a minimum price.

15. The medium of claim 13, wherein the selecting is further based on at least one of past transaction histories of:
a party that offers the item for sale;
the potential purchaser; and
items in the category.

16. The medium of claim 13, the information, when read by the machine, further causing the machine to direct the potential purchaser to a third party for purchasing the item in accordance with the selected pricing structure.

17. The medium of claim 13, wherein the item includes at least one of a piece of content and a tangible item.

18. The medium of claim 17, wherein the piece of content includes at least one of a textual content, an image, an audio, a video, and a combination thereof.
